(19) United States
(12) Patent Application Publication
(10) Pub. No.: US 2011/0072995 A1
(43) Pub. Date: Mar. 31, 2011

(54) PRINTER HAVING DETACHABLY MOUNTED PLATEN ROLLER

(75) Inventor: Shigeyuki KAMATA, Miyagi-Ken (JP)

(73) Assignee: ALPS ELECTRIC CO., LTD, Tokyo (JP)

(21) Appl. No.: 12/851,912

(22) Filed: Aug. 6, 2010

(30) Foreign Application Priority Data
Sep. 30, 2009 (JP) 2009-227300

(51) Int. Cl. B41F 1/38

(52) U.S. Cl. 101/480

(57) ABSTRACT

A printer includes a platen roller that is detachably supported on a support section that is formed in a frame, and a head unit that is supported on the frame and can be moved in a direction in which the head unit is brought into pressure-contact with the platen roller, The printer also includes a regulating member that is movably supported on the frame, and the regulating member has a regulating section that regulates a shaft of the platen roller to deviate from the support section and a pressing section that is arranged on the opposite side to the regulating section, with the head unit interposed therebetween. A first plate spring that presses the head unit against the platen roller and a second plate spring that presses the pressing section so as to bias the regulating member in a direction in which the regulating section can regulate the shaft are provided in an area on the opposite to the platen roller, with the head unit interposed therebetween.

### CROSS REFERENCE TO RELATED APPLICATION

The present invention contains subject matter related to and claims the benefit of Japanese Patent Application JP 2009-227300 filed in the Japanese Patent Office on Sep. 30, 2009, the entire contents of which is incorporated herein by reference.

### BACKGROUND OF THE DISCLOSURE

1. Technical Field

The present invention relates a printer that detachably mounts a platen roller when a paper for printing is set or the like.

2. Related Art

A compact printer is used in the receipt issuing section or the like of a cash register or various other like apparatus. As described in Japanese Unexamined Patent Application Publication No. 2007-118247 and Japanese Unexamined Patent Application Publication No. 2008-179079, this kind of compact printer is a line printer that includes a thermal head and has a head unit and a platen roller that pushes the head unit. Since the platen roller is detachably mounted, the platen roller is detached and thus the paper for printing is set in the front of the head unit. Then, the platen roller is mounted so that the paper for printing is interposed between the head unit and the platen roller.

In the printer that is described in Japanese Unexamined Patent Application Publication No. 2007-118247, a shaft of the platen roller is mounted in a groove section that is formed in a frame. Hook elements that are arranged at opposite sides in an axial direction of the platen roller are connected to each other and thus rotatably supported in the frame. Two hook elements are rotated together and then the shaft is regulated so as not to deviate from the groove section after the shaft of the platen roller is mounted in the groove section.

In the printer that is described in Japanese Unexamined Patent Application Publication No. 2008-179079, when a shaft of the platen roller is mounted in a groove section that is formed in the frame, the shaft is pressed against a upper edge of the groove section by a release arm that is pressed by a coil spring so that the platen roller is regulated so as not to deviate from the frame.

The printer described in Japanese Unexamined Patent Application Publication No. 2007-118247 is unstable in the regulation of the shaft because rotated hook elements face an opening of the groove section after the shaft of the platen roller is mounted in the groove section of the frame so as to regulate the deviation of the shaft from the groove section of the shaft.

In the printer that is described in Japanese Unexamined Patent Application Publication No. 2008-179079, a release arm is biased by a coil spring and a head unit is pressed against the platen roller by another coil spring. Because there is a limit of shortening the length of the coil spring being installed, large space is needed to arrange two coil springs and thus a problem in downsizing the printer remains to be solved.

Also, in the printer that is described in Japanese Unexamined Patent Application Publication No. 2008-179079, the groove section formed in the frame is opened toward the head unit and thus there is a need to insert the shaft of the platen roller from the side in which the head unit is provided toward the groove section. Furthermore, because the shaft needs to forcibly ride over the release arm that is biased by the coil spring and thus the shaft is inserted to the groove section, the mounting operation of the platen roller is difficult.

These and other drawbacks exist.

### SUMMARY OF THE DISCLOSURE

Embodiments of the disclosure solve the known problems described above and have a goal of providing a printer that can arrange two kinds of springs in a minimum space and can realize a compact size thereof.

Also, it is desirable to provide a printer from which the platen roller can easily be attached/detached.

According to various embodiments, a printer includes: a platen roller that is detachably supported on a support section that is formed in a frame, and a head unit that is supported on the frame and can be moved in a direction in which the head unit is brought into pressure-contact with the platen roller, wherein a regulating member is movably supported on the frame, and the regulating member has a regulating section that regulates a shaft of the platen roller to deviate from the support section and a pressing section that is arranged on the opposite side to the regulating section, with the head unit interposed therebetween, and wherein, a first plate spring that presses the head unit against the platen roller and a second plate spring that presses the pressing section so as to bias the regulating member in a direction in which the regulating section can regulate the shaft are provided in an area on the opposite to the platen roller, with the head unit interposed therebetween.

A printer according to various embodiments is provided such that the head unit and the regulating member are biased together with the plate spring. Because the first plate spring and the second plate spring are housed in the same area, the printer can be downsized.

For example, a printer according to the various embodiment may be a printer wherein the first plate spring and the second plate spring are independently formed and the first plate spring and the second plate spring are overlapped and arranged in the area.

The first plate spring and the second plate spring are arranged in the same area respectively, however because two plate springs are overlapped on each other, the plate springs are easily provided within a narrow space.

Also, various embodiments may have a printer wherein both the first plate spring and the second plate spring have a curved section, a engaging piece that extends to one direction from the curved section and a biased piece that extends in the other direction therefrom, wherein the curved section of the first plate spring and the curved section of the second plate spring are overlapped, each of the curved sections is arranged so as to surround a support shaft that rotatably supports the regulating member, the engaging piece engages with the frame, the biased piece of the first plate spring press the head unit, and the biased piece of the second plate spring presses the pressing section.

Two plate springs are overlapped with each other and are arranged so as to surround the support shaft of the regulating member, so that the lengths of the deformation sections of two plate springs can be secured sufficiently and furthermore the plate springs can be arranged within a narrow area.

Otherwise, embodiments may include a printer wherein the first plate spring and the second plate spring are branched from one main plate spring and are integrally formed.

Because the plate spring that presses the head unit and the plate spring that presses the regulating member are formed from one plate spring, the number of parts thereof can be reduced.

In this case, embodiments may include a printer wherein each of the first plate spring and the second plate spring of the main plate spring has a curved section, an engaging piece that extends in one direction from the curved section and a biased piece that extends in the other direction therefrom, and wherein the curved section is arranged so as to surround the support shaft that rotatably supports the regulating member, the engaging piece engages with the frame, the biased piece of the first plate spring presses the head unit, and the biased piece of the second plate spring presses the pressing section.

In above described invention, the deformation section of the plate spring can secure a sufficient length and the plate spring can be arranged within a narrow area.

Also, various embodiments may include a printer wherein the head unit and the pressing section are biased in opposite directions from each other in the area.

The various embodiments have the effect that the plate spring is arranged in a narrow space, furthermore the length for deformation can be secured sufficiently so that the head unit can be biased and the regulating member can be biased. Also, deviation of the shaft of the platen roller from the frame can be easily prevented by a regulation section that is urged.

### BRIEF DESCRIPTION OF THE DRAWINGS

FIG. 1 shows an exploded perspective view illustrating a printer of an embodiment of the disclosure.

FIG. 2 shows a cross sectional view illustrating the printer of FIG. 1.

FIG. 3 shows an exploded perspective view illustrating a printer of an embodiment of the disclosure.

FIG. 4 is shows a cross sectional view illustrating the printer of FIG. 2.

### DESCRIPTION OF EXEMPLARY EMBODIMENTS

The following description is intended to convey a thorough understanding of the embodiments described by providing a number of specific embodiments and details involving printers having detachably mounted platen rollers. It should be appreciated, however, that the present invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending on specific design and other needs.

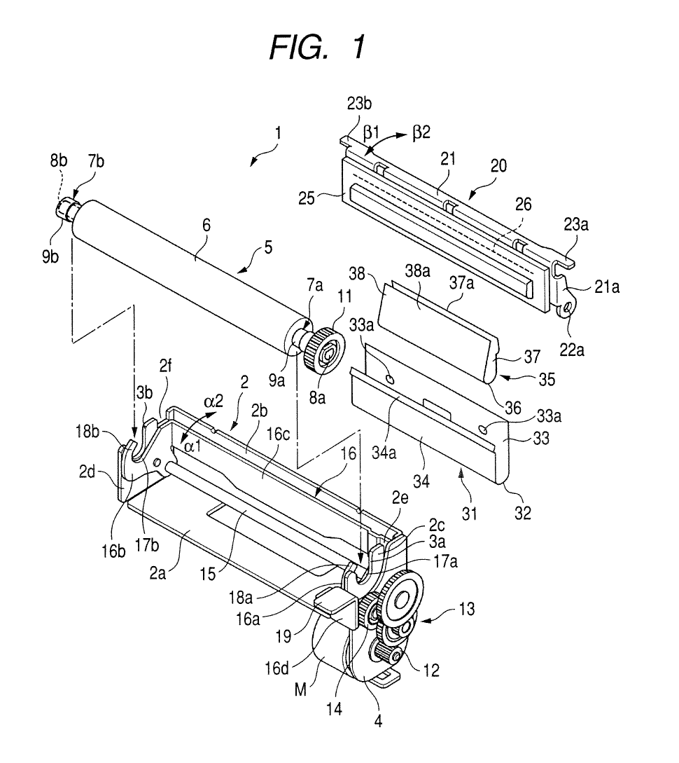

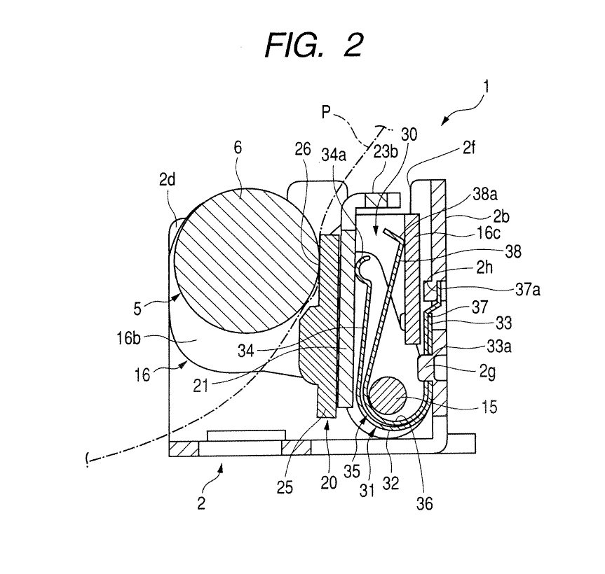

A printer 1 an exemplary embodiment shown in FIG. 1 and FIG. 2 may be used in the receipt issuing section or the like of a cash register or other apparatus.

The printer 1 may have a frame 2. The frame 2 may be formed by bending a sheet metal material, for example. The frame 2 may have a bottom plate section 2a and a rear plate section 2b that may be formed by bending the same metal plate to a right angle. Also, a right side plate section 2c and a left side plate section 2d may be formed together by bending from both side sections of the rear plate section 2b to a right angle. Accordingly, the right side plate section 2c and the left side plate section 2d may be parallel to each other.

A concave support section 3a may be formed in the right side plate section 2c of the frame 2, and a concave support section 3b may be formed in the left side plate section 2d. The concave support sections 3a and 3b may be support sections that support both end sections of the platen roller 5. The concave support section 3a that is formed in the right side plate section 2c and the concave support section 3b that is formed in the left side plate section 2d may be located at the same distance from the rear plate section 2b, and the openings thereof may have the same shape. The concave support sections 3a and 3b may be recessed parallel to the rear plate section 2b may be are upwardly opened together.

The platen roller 5 may have a platen main body 6 that may have a round rod shape formed of a synthetic rubber material or the like, a shaft 7a that is provided at the right side end section and a shaft 7b that is provided at the left side end section of the platen main body 6. A sleeve 9a may be rotatably mounted in the outer periphery of a shaft 8a that is fixed to the platen main body 6 at the right side shaft 7a. Thus, a driven gear 11 may be fixed to a leading section of the shaft 8a that is projected from the sleeve 9a. A shaft 8b may be fixed to the platen main body 6 at the left side shaft 7b and a sleeve 9b may be rotatably provided on the outer periphery of the shaft 8b.

A motor bracket 4 may be fixed at the outside of the right side plate section 2c of the frame 2. The motor bracket 4 may be formed from a metal plate and may be fixed by welding to the outside surface of the right side plate section 2c and at the same time a portion thereof further extends towards the downside than the right side plate section 2c. A motor M for transferring papers may be provided on the downside of the bottom plate section 2a of the frame 2 and the motor M may be fixed at the motor bracket 4.

A pinion gear 12 may be fixed to an output shaft of the motor M. A reduction gear train 13 that may reduce and transfer a rotation force of the pinion gear 12 and a driving gear 14 that may be driven by the power reduced in the reduction gear train 13 may be provided at the motor bracket 4. When the shaft 7a of the platen roller 5 is mounted at the concave support section 3a and the shaft 7b is mounted at the concave support section 3b, a driven gear 11 fixed to the shaft 8a may mesh with the driving gear 14.

Both end sections of a metal support shaft 15 may be fixed between the right side plate section 2c and the left side plate section 2d of the frame 2 respectively. A regulating member 16 may be provided on inside of the frame 2. The regulating member 16 may be formed by bending a metal plate and integrally forms a right side moving section 16a, the left side moving section 16b and a pressing section 16c that may connect both moving sections 16a and 16b are integrally formed. An insertion hole may be opened at the right side moving section 16a and the left side moving section 16b, the insertion hole may be inserted in the support shaft 15 and the right side moving section 16a and the left side moving section 16b may be rotatably supported by the support shaft 15 as a fulcrum.

The right side moving section 16a of the regulating member 16 may rotate at a position that is nearly in close contact with the inside of the right side plate section 2c and the left side moving section 16b may rotate at a position that that is nearly in close contact with the inside of the left side plate section 2d of the frame 2. As shown in FIG. 2, the pressing section 16c of the regulating member 16 may rotate at a position interval to inside of the rear plate section 2b of the frame 2.

A groove section 17a may be formed at the right side moving section 16a of the regulating member 16 and a regulating section 18a may be formed at the leading section thereof. Also, a groove section 17b may be formed at the left side moving section 16b and a regulating section 18b may be formed at the leading section thereof.

When the regulating member 16 rotates toward a al direction, the groove section 17a formed in the right side moving section 16a may substantially conform to the concave support section 3a formed at the right side plate section 2c of the frame 2 and thus the groove section 17a may be opened to upward together with the concave support section 3a. Similar to the above description, the left side groove section 17b may conform to the concave support section 3b and thus the groove section 17b may be opened to upward together with the concave support section 3b. When the regulating member 16 rotates toward a α2 direction, at least a portion of the opening section of the concave support section 3a may be closed by the regulating section 18a formed in the right side moving section 16a and at least a portion of the opening section of the concave support section 3b may be closed by the regulating section 18b formed in the left side moving section 16b.

A folded piece 16d may be bent to a right angle to the front direction of the right side moving section 16a at the regulating member 16 and an upper end of the folded piece 16d may be further bent to a right angle to the front direction so that a handle section 19 may be formed. When the handle section 19 is pressed, the regulating member 16 can be rotated toward the al direction.

A head unit 20 may be attached to inside of the frame 2. A head support member 21 may be provided at the head unit 20. The head support member 21 may be formed by folding a metal plate. A right side support plate section 21a and a left side support plate section may be formed by folding at the head support member 21. A support hole 22a may be opened to the right side support plate section 21a and a support hole also may be similarly opened to the left side support plate. As shown in FIG. 2, each of the support holes may pass through the support shaft 15 and the head support member 21 may be rotatably supported about the support shaft 15 as a fulcrum toward the β1-β2 direction.

As shown in FIG. 1, a right side stopper 23a may be integrally formed on the right side upper section and a left side stopper 23b may be integrally formed on the left side upper section at the head support member 21. A regulating groove section 2e may be formed on the upper section of the right side plate section 2c and a regulating groove section 2f may be formed on the upper section of the left side plate section 2d of the frame 2. As shown in FIG. 2, when the head support member 21 is rotatably supported about the support shaft 15, the right side stopper 23a may be entered into inside of the regulating groove section 2e and the left side stopper 23b may be entered into inside of the regulating groove section 2f. The head support member 21 can rotate within a range in which the right side stopper 23a and the left side stopper 23b can be moved inside of the movement range of the regulating groove section 2e and the regulating groove section 2f.

As shown in FIG. 1 and FIG. 2, the head main body 25 may be fixed to the front surface of the head support member 21. The head main body 25 may be formed of a thermal resistant ceramic material or a synthetic resin material and a heat generation section 26 may be provided on the upper side of the front surface thereof. The heat generation section 26 may have a plurality of heat generation points and the heat generation points may be arranged in a line with a predetermined pitch toward the longitudinal direction of the head main body 25.

As shown in FIG. 2, a space between the head unit 20 and the rear plate section 2b of the frame 2 may be a pressed area 30 and the pressing section 16c of the regulating member 16 may be positioned within the biased area 30. In other words, the pressing section 16c of the regulating member 16 may be arranged on a side opposite to the side in which the regulating sections 18a and 18b may be formed while interposing the head unit 20. Also, the pressing section 16c may be arranged on a side opposite to the side in which the regulating sections 18a and 18b are formed while interposing the support shaft 15, and the pressing section 16c is arranged on a side opposite to the head unit 20 while interposing the support shaft 15.

A first plate spring 31 and a second plate spring 35 may be provided at the biased area 30. The first plate spring 31 and the second plate spring 35 may be formed from a spring nature stainless steel plate or a phosphor bronze plate.

The first plate spring 31 may be integrally formed with the curved section 32, a hanging piece 33 that may continuously extend from the curved section 32 to the rear direction and a biased piece 34 that may continuously extend from the curved section 32 to the front direction. A pair of positioning holes 33a may be opened at the hanging piece 33. As shown in FIG. 2, a positioning protrusion 2g that is projected to the front direction at the rear plate section 2b of the frame 2 may be formed at two places, respective positioning hole 33a may be fitted to the positioning protrusion 2g and the hanging piece 33 may be positioned and arranged at the front surface of the rear plate section 2b. A ridge section 34a that may be bent toward the front direction at the upper edge of the biased piece 34 may be integrally formed.

In the state that the first plate spring 31 exerts a forced contraction deformation force so as to approach the hanging piece 33 and the biased piece 34 to each other, the curved section 32 may be mounted so as to surround the support shaft 15 in the biased area 30. When the contraction deformation force is released, the ridge section 34a presses the rear surface of the head support member 21 of the head unit 20 by the resilience restoring force, so that the head unit 20 may rotate toward the pi direction about the support shaft 15 as a fulcrum and the heat generation section 26 of the head main body 25 may be pressed to the platen main body 6.

A second plate spring 35 may be integrally formed with a curved section 36, a hanging piece 37 that may continuously extend from the curved section 36 to the rear direction and a biased piece 38 that may continuously extend from the curved section 36 to the front direction. The hanging piece 37 may be interposed between a pair of positioning protrusion 2g that may be provided at the rear plate section 2b of the frame 2 and may be positioned and arranged in the front surface of the rear plate section 2b. As shown in FIG. 2, an upper edge 37a of a hanging piece 37 may lock with a lock section 2h formed at the rear plate section 2b from the rear surface side. Also, a ridge section 38a that is bent to the rearward may be formed at the upper edge of the biased piece 38.

As shown in FIG. 2, the second plate spring 35 may be arranged inside of the first plate spring 31 in an overlapped state and the curved section 36 of the second plate spring 35 may be overlapped inside of the curved section 32 of the first plate spring 31. Accordingly, the hanging piece 37 and the biased piece 38 of the second plate spring 35 may be positioned inside of the hanging piece 33 and biased piece 34 of the first plate spring 31.

In the state that the hanging piece 37 and the biased piece 38 are forcedly widely deformed so as to separate to each other, the second plate spring 35 may be mounted so that the curved section 36 surrounds the support shaft 15. When the wide deformation force is released, the ridge section 38a of the biased piece 38 presses the pressing section 16c to the rear plate section 2b and the regulating member 16 may be biased toward the α2 direction by the resilient return force.

As shown in—FIG. 2, in the state that the printer 1 is assembled, one side shaft 7a of the platen roller 5 may be inserted inside of the concave support section 3a that is formed on the right side plate section 2c of the frame 2 and the other side shaft 7b may be inserted inside of the concave support section 3b that may be formed in the left side plate section 2d. Because the biasing force is given toward the rear direction from the biased piece 38 of the second plate spring 35 to the pressing section 16c, the regulating member 16 may be biased toward the α2 direction about the support shaft 15 as a fulcrum. The regulating section 18a that is provided in the regulating member 16 presses the shaft 7a of the platen roller 5 and the sleeve 9a of the shaft 7a may be maintained at the concave support section 3a and the regulating section 18a by the biasing force. Similar to above description, the sleeve 9b of the other side shaft 7b may be maintained at the left side concave support section 3b and regulating section 18b.

The shaft 7a and the shaft 7b of the platen roller 5 may be maintained so as not to move within the concave support section 3a and the concave support section 3b of the frame 2; and the driven gear 11 that is provided in the shaft 7a may be meshed with the driving gear 14 that is provided in the frame 2.

The head unit 20 can rotate about the support shaft 15 as a fulcrum within a range in which the right side stopper 23a and the left side stopper 23b may be moved inside the movement range of the regulating groove section 2e and the regulating groove section 2f, and the head unit 20 may receive the pressing force of the biased piece 34 of the first plate spring 31 so that the head unit 20 may rotate toward the β1 direction and the heat generation section 26 of the head main body 25 is pressed to the platen main body 6.

As shown in FIG. 2, in the state where the paper P for printing is inserted between the platen main body 6 and the head main body 25, when the motor M for transferring paper rotates, the platen roller 5 may rotate and the paper P for printing may be transferred; and the heat generation point of the heat generation section 26 of the head main body 25 may be selected so that printing is performed on the heat sensitive paper P for printing. At this time, letter row may be printed per a row on the printing paper.

When the paper P for printing is changed or new paper P for printing is charged, the handle section 19 that is integrally formed in the regulating member 16 is pressed and the regulating member 16 may be rotated to the al direction against the pressed force of the second plate spring 35. Because the regulating section 18a and the regulating section 18b that are formed on the regulating member 16 are simultaneously deviated from the shaft 7a and the shaft 7b, the platen roller 5 can be removed from the frame 2.

At this time, the platen roller 5 may be simply vertically lifted directly upward in a direction parallel with the rear plate section 2b, and then the platen roller 5 can be removed from the frame 2. When the platen roller 5 is removed, the head unit 20 that is biased by the first plate spring 31 may rotate further toward the al direction than the posture of FIG. 2, however the right side stopper 23a and the left side stopper 23b may be regulated at the regulating groove section 2e and the regulating groove section 2f. Accordingly, the head unit 20 may be stable in the posture that is rotated slightly more toward the β1 direction than the posture shown in FIG. 2. Accordingly, after that, the platen roller 5 can be easily mounted from upward to the downward.

The printer 1 may be provided such that the head unit 20 and the regulating member 16 may be rotatably supported by the common support shaft 15, the second plate spring 35 are overlapped inside of the first plate spring 31; and the curved section 32 and the curved section 36 may be arranged in the biased area 30 so as to surround the support shaft 15. Thus, the first plate spring 31 and the second plate spring 35 can arrange and secure the resilient deformation section sufficiently long within a narrow area. Accordingly, the printer 1 can be of a compact size and the resilient force of the first plate spring 31 and the second plate spring 35 can easily be set to an appropriate size.

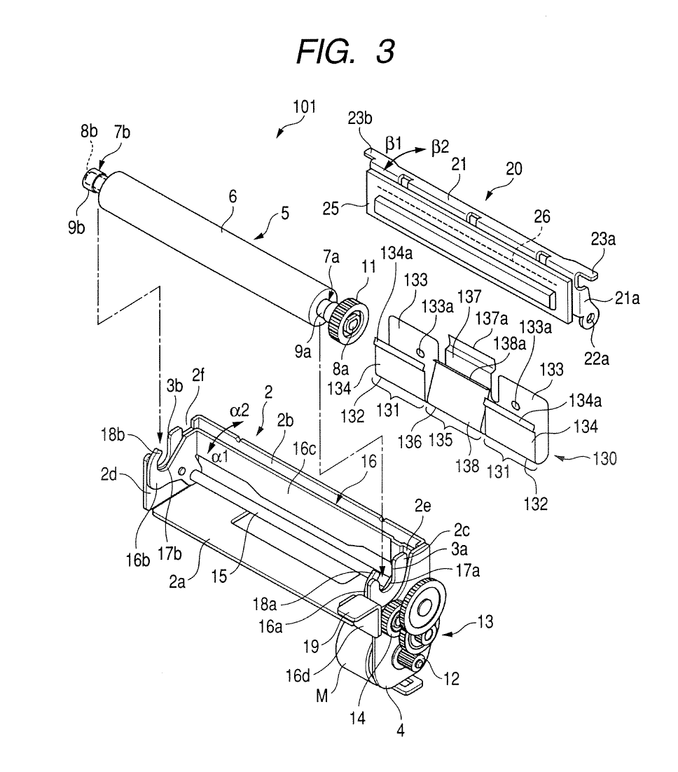

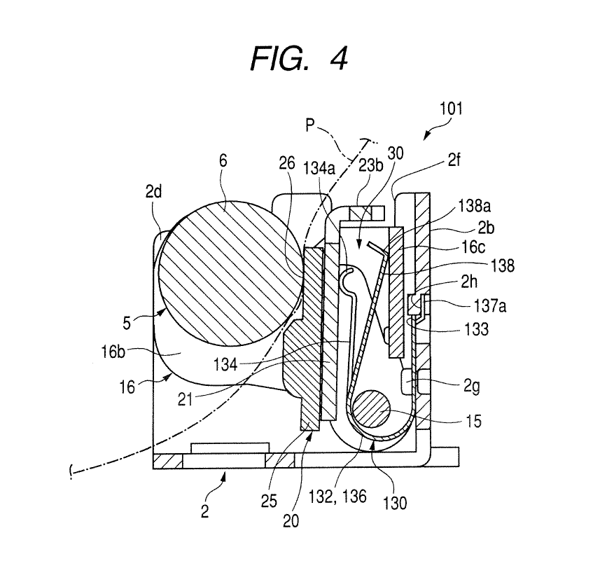

A printer 101 according to various embodiments shown in FIG. 3 and FIG. 4 uses one main body plate spring 130 instead of the first plate spring 31 and the second plate spring 35 of the printer 1 shown in FIG. 1 and FIG. 2. Because other configurations except the plate spring of the printer 101 are the same as those of the printer 1 as described above, the constituent elements described above are given similar numbers in FIG. 1 and FIG. 2, thus are not specifically described here.

The main body plate spring 130 shown in FIG. 3 and FIG. 4 may be integrally formed from a stainless steel plate spring material or a phosphor bronze plate. The main body plate spring 130 may form each of first plate springs 131 on both the left and right sides and a second plate spring 135 at center section.

The first plate spring 131 may be integrally formed with a curved section 132, a hanging piece 133 and a biased piece 134. A positioning hole 133a may be formed in the hanging piece 133 that may be respectively formed on the left and right side first plate spring 131. The second plate spring 135 may be integrally formed with a curved section 136, a hanging piece 137 and a biased piece 138.

As shown in FIG. 4, the main body plate spring 130 may be mounted within the biased area 30 between the head unit 20 and the rear plate section 2b. At this time, the curved section 132 and the curved section 136 may be mounted so as to surround the support shaft 15 from the lower side. Also, the positioning hole 133a that is formed in the hanging piece 133 of the first plate spring 131 may be fitted to the positioning protrusion 2g that is formed in the rear plate section 2b so that the main body plate spring 130 is positioned.

The head unit 20 may be pressed to the platen roller 5 by a ridge section 134a that may be formed in two first plate spring 131. Also, a upper edge 137a of the hanging piece 137 of the second plate spring 135 may be hung at the rear surface of the lock section 2h that is formed in the rear plate section 2b and the ridge section 138a of the biased piece 138 may be resiliently pressed to the pressing section 16c of the regulating member 16 so that the regulating member 16 may be biased to the α2 direction.

In printer 101, because the plate spring is formed as one, the number of parts can be reduced, and the plate spring can be arranged within a narrow biased area 30, furthermore each of the resilient deformation sections of the first plate spring 131 and the second plate spring 135 can be secured sufficiently long.

Also, in respective embodiments, the head main body 25 may be the thermal head, however the various embodiments may also have a printing means besides the thermal head.

It should be understood by those skilled in the art that various modifications, combinations, sub-combinations and alterations may occur depending on design requirements and other factors insofar as they are within the scope of the appended claims of the equivalents thereof.

Accordingly, the embodiments of the present inventions are not to be limited in scope by the specific embodiments described herein. Further, although some of the embodiments of the present invention have been described herein in the context of a particular implementation in a particular environment for a particular purpose, those of ordinary skill in the art should recognize that its usefulness is not limited thereto and that the embodiments of the present inventions can be beneficially implemented in any number of environments for any number of purposes. Accordingly, the claims set forth below should be construed in view of the full breadth and spirit of the embodiments of the present inventions as disclosed herein. While the foregoing description includes many details and specificities, it is to be understood that these have been included for purposes of explanation only, and are not to be interpreted as limitations of the invention. Many modifications to the embodiments described above can be made without departing from the spirit and scope of the invention.

What is claimed is:

1. A printer comprising:
a platen roller that is detachably supported on a support section that is formed in a frame, and
a head unit that is supported on the frame and is movable in a direction in which the head unit is brought into pressure-contact with the platen roller,
wherein a regulating member is movably supported on the frame, and the regulating member has a regulating section that regulates a shaft of the platen roller to deviate from the support section and a pressing section that is arranged on the opposite side to the regulating section, with the head unit interposed therebetween, and
wherein, a first plate spring that presses the head unit against the platen roller and a second plate spring that presses the pressing section so as to bias the regulating member in a direction in which the regulating section can regulate the shaft are provided in an area on the opposite side to the platen roller, with the head unit interposed therebetween.

2. The printer according to claim 1, wherein the first plate spring and the second plate spring are independently formed and the first plate spring and the second plate spring are overlapped and arranged in the area on the opposite side to the platen roller.

3. The printer according to claim 2, wherein both the first plate spring and the second plate spring have a curved section, a engaging piece that extends to one direction from the curved section and a biased piece that extends in the other direction therefrom,
wherein the curved section of the first plate spring and the curved section of the second plate spring are overlapped, each of the curved sections is arranged so as to surround a support shaft that rotatably supports the regulating member, the engaging piece engages with the frame, the biased piece of the first plate spring presses the head unit, and the biased piece of the second plate spring presses the pressing section.

4. The printer according to claim 1, wherein the first plate spring and the second plate spring are branched from one main plate spring and are integrally formed.

5. The printer according to claim 4, wherein each of the first plate spring and the second plate spring of the main plate spring have a curved section, an engaging piece that extends in one direction from the curved section and a biased piece that extends in the other direction therefrom, and
wherein the curved section is arranged so as to surround the support shaft that rotatably supports the regulating member, the engaging piece engages with the frame, the biased piece of the first plate spring presses the head unit, and the biased piece of the second plate spring presses the pressing section.

6. The printer according to claim 1, wherein the head unit and the pressing section are biased in opposite directions from each other in the area on the opposite side to the platen roller.
